(19) United States
(12) Patent Application Publication
(10) Pub. No.: US 2026/0229750 A1
(43) Pub. Date: Aug. 6, 2026

(54) SECONDARY BATTERY AND ELECTRIC DEVICE

(71) Applicant: Ningde Amperex Technology Limited, Ningde (CN)

(72) Inventors: Xiao CHEN, Ningde (CN); Ao LIU, Ningde (CN); Fei WU, Ningde (CN); Changming QU, Ningde (CN)

(73) Assignee: Ningde Amperex Technology Limited, Ningde (CN)

(21) Appl. No.: 19/635,070

(22) Filed: Mar. 31, 2026

Related U.S. Application Data
(63) Continuation of application No. PCT/CN2025/082211, filed on Mar. 12, 2025.

(30) Foreign Application Priority Data
Mar. 31, 2024 (CN) 202410383505.4

(51) Int. Cl. H01M 50/595; H01M 10/0587; H01M 50/486; H01M 50/491; H01M 50/538

(52) U.S. Cl. CPC H01M 50/595; H01M 10/0587; H01M 50/486; H01M 50/491; H01M 50/538

(57) ABSTRACT

An electrode assembly of the secondary battery includes a positive electrode plate, a separator, and a negative electrode plate stacked together, and further includes a first-type adhesive tape. The first-type adhesive tape includes a substrate layer. A thickness of the substrate layer is H μm and 8≤H≤20. A porosity of the substrate layer is φ and satisfies 20%≤φ≤60%. The positive electrode plate includes a positive electrode current collector, a first positive electrode active material layer, and a second positive electrode active material layer stacked together, and further includes a positive electrode tab. The first positive electrode active material layer is provided with a first groove, and the positive electrode tab is accommodated in the first groove.

### CROSS-REFERENCE TO RELATED APPLICATIONS

This application is a continuation application of International Application No. PCT/CN2025/082211, filed on Mar. 12, 2025, which claims priority to Chinese Patent Application No. CN202410383505.4, filed on Mar. 31, 2024 and entitled “SECONDARY BATTERY AND ELECTRIC DEVICE”, the contents of which are incorporated herein by reference in its entirety.

### TECHNICAL FIELD

This application relates to the field of battery technologies, specifically to a secondary battery and an electric device.

### BACKGROUND

With the rapid development of electronic information technology, various electronic devices are advancing toward intelligence and multifunctionality, imposing increasingly high demands on the discharge capacity of batteries. Therefore, how to increase the discharge capacity of batteries has become an urgent issue to be addressed in the battery field.

### SUMMARY

This application provides a secondary battery and an electric device capable of increasing the discharge capacity of an electrochemical apparatus.

According to a first aspect, this application provides a secondary battery including a housing, an electrolyte, and an electrode assembly. The electrode assembly and the electrolyte are accommodated in the housing, where the electrode assembly includes a positive electrode plate, a separator, a negative electrode plate, and a first-type adhesive tape, and the separator is disposed between the positive electrode plate and the negative electrode plate.

The first-type adhesive tape includes a substrate layer; a thickness of the substrate layer is H μm and satisfies 8≤H≤20; the substrate layer has pores for metal cations to pass through; and the porosity of the substrate layer is φ, satisfying 20%≤φ≤60%.

The positive electrode plate includes:
a positive electrode current collector;
a first positive electrode active material layer coated on a first surface of the positive electrode current collector, the first positive electrode active material layer is provided with a first groove, and a portion of the positive electrode current collector is exposed from the first groove;
a second positive electrode active material layer coated on a second surface of the positive electrode current collector, the second surface of the positive electrode current collector being opposite to the first surface of the positive electrode current collector; and
a positive electrode tab accommodated in the first groove, the positive electrode tab being electrically connected to the positive electrode current collector; where
the first-type adhesive tape includes a first adhesive tape, and the first adhesive tape is attached to the first positive electrode active material layer and covers the first groove and the positive electrode tab.

In the above technical solution, the first-type adhesive tape includes the substrate layer, and the thickness of the substrate layer is H μm and 8≤H≤20. On one hand, this enables burrs on the positive electrode tab to be less likely to penetrate through the first-type adhesive tape and contact the negative electrode plate. On the other hand, this enables the first-type adhesive tape to have a small size and a small impedance in a thickness direction of the positive electrode current collector, resulting in a small impact on the discharge capacity of the secondary battery. The substrate layer has pores for metal cations to pass through, and the porosity of the substrate layer is q, satisfying 20%≤φ≤60%. On one hand, this enables metal cations to pass through the first-type adhesive tape, so that a portion of the first positive electrode active material layer covered by the first-type adhesive tape can also absorb and release metal cations, thus increasing an effective area of the first positive electrode active material layer and increasing the discharge capacity of the secondary battery. On the other hand, this can reduce the probability of deformation of the first-type adhesive tape during a preparation process of the secondary battery.

In some embodiments, the porosity of the substrate layer is q, satisfying 30%≤φ≤55%.

In the above technical solution, the porosity q of the substrate layer satisfies 30%≤φ≤55%. On one hand, metal cations can more easily pass through the first-type adhesive tape, accelerating a speed at which the metal cations pass through the first-type adhesive tape and reducing the probability of metal cation precipitation. On the other hand, the probability of deformation of the first-type adhesive tape during the preparation process of the secondary battery can be further reduced.

In some embodiments, the substrate layer is made of at least one of polyethylene, polypropylene, polyethylene terephthalate, polyimide, polyamide, spandex, or aramid.

In the above technical solution, the substrate layer being made of at least one of polyethylene, polypropylene, polyethylene terephthalate, polyimide, polyamide, spandex, or aramid enables the substrate layer to have pores with a porosity ranging from 20% to 60%.

In some embodiments, the thickness of the substrate layer is H μm, satisfying 8≤H≤16.

In the above technical solution, the thickness of the substrate layer is H μm and 8≤H≤16. On one hand, burrs on the positive electrode tab can be further prevented from penetrating through the first-type adhesive tape and contacting the negative electrode plate. On the other hand, the first-type adhesive tape can have a small size in the thickness direction of the positive electrode current collector, resulting in a small impact on the discharge capacity of the secondary battery.

In some embodiments, the thickness of the substrate layer is H μm and 10≤H≤16.

In the above technical solution, the thickness of the substrate layer is H μm and 10≤H≤16. On one hand, burrs on the positive electrode tab can be further prevented from penetrating through the first-type adhesive tape and contacting the negative electrode plate. On the other hand, the first-type adhesive tape can have a small size in the thickness direction of the positive electrode current collector, resulting in a small impact on the discharge capacity of the secondary battery.

In some embodiments, the thickness of the substrate layer is H, and the porosity of the substrate layer is φ, satisfying 14≤H/φ≤67.

In the above technical solution, since the value of H/q in the substrate layer is positively correlated with the impedance of the substrate layer, by ensuring that the thickness H of the substrate layer and the porosity q of the substrate layer satisfy 14≤H/φ≤67, on one hand, the substrate layer can have a certain impedance, facilitating the preparation of the substrate layer; on the other hand, the impedance of the substrate layer can be reduced, thereby reducing the probability of metal ion precipitation in the secondary battery.

In some embodiments, the first-type adhesive tape further includes an adhesive layer, the adhesive layer is made of at least one of polyolefin, polyacrylate, polyacrylic acid, or derivatives thereof, and the adhesive layer and the substrate layer are stacked.

In the above technical solution, the first-type adhesive tape is provided with an adhesive layer, and the adhesive layer and the substrate layer are stacked, facilitating attachment of the first-type adhesive tape, so that the position of the first-type adhesive tape is more stable after attachment. The adhesive layer is made of at least one of polyolefin, polyacrylate, polyacrylic acid, or derivatives thereof, achieving good adhesion of the adhesive layer.

In some embodiments, a second groove is provided at a position of the second positive electrode active material layer corresponding to the first groove, and a portion of the positive electrode current collector is exposed from the second groove; and
the first-type adhesive tape further includes a second adhesive tape, and the second adhesive tape is attached to the second positive electrode active material layer and covers the second groove.

In the above technical solution, the second adhesive tape is attached to the second positive electrode active material layer and covers the second groove, achieving an insulating effect between the positive electrode plate and the negative electrode plate, and reducing the probability of contact between the positive electrode tab and the negative electrode plate, thereby improving the reliability of the secondary battery. Additionally, a portion of the second positive electrode active material layer shielded by the second adhesive tape can absorb and release metal cations, increasing the discharge capacity of the secondary battery.

In some embodiments, the negative electrode plate includes:
a negative electrode current collector;
a first negative electrode active material layer coated on a first surface of the negative electrode current collector; and
a second negative electrode active material layer coated on a second surface of the negative electrode current collector, the second surface of the negative electrode current collector being opposite to first surface of the negative electrode current collector; where
the first-type adhesive tape includes a third adhesive tape, the third adhesive tape is attached to the first negative electrode active material layer, and along a thickness direction of the negative electrode current collector, a projection of the positive electrode tab is located within a projection of the third adhesive tape.

In the above technical solution, the third adhesive tape is attached to the first negative electrode active material layer, and the projection of the positive electrode tab is located within the projection of the third adhesive tape along the thickness direction of the negative electrode current collector, achieving an insulating effect between the positive electrode plate and the negative electrode plate. Since the projection of the positive electrode tab is covered by the projection of the third adhesive tape, the insulating effect of the third adhesive tape is enhanced, reducing the probability of contact between the positive electrode tab and the negative electrode plate, thereby improving the reliability of the secondary battery. Additionally, a portion of the first negative electrode active material layer shielded by the third adhesive tape can absorb and release metal cations, increasing the discharge capacity of the secondary battery.

In some embodiments, the first-type adhesive tape further includes a fourth adhesive tape, the fourth adhesive tape is attached to the second negative electrode active material layer, and along the thickness direction of the negative electrode current collector, the projection of the positive electrode tab is located within a projection of the fourth adhesive tape.

In the above technical solution, the fourth adhesive tape is attached to the second negative electrode active material layer, and the projection of the positive electrode tab is located within the projection of the fourth adhesive tape along the thickness direction of the negative electrode current collector, achieving an insulating effect between the positive electrode plate and the negative electrode plate. Since the projection of the positive electrode tab is covered by the projection of the fourth adhesive tape, the insulating effect of the fourth adhesive tape is enhanced, reducing the probability of contact between the positive electrode tab and the negative electrode plate, thereby improving the reliability of the secondary battery. Additionally, a portion of the second negative electrode active material layer shielded by the fourth adhesive tape can absorb and release metal cations, increasing the discharge capacity of the secondary battery.

In some embodiments, along a length direction of the positive electrode current collector, a width of the third adhesive tape is less than a width of the first adhesive tape, and a width of the fourth adhesive tape is less than the width of the first adhesive tape.

In the above technical solution, although metal cations can pass through the first-type adhesive tape, the speed at which the portion of the active material layer shielded by the first-type adhesive tape absorbs and releases metal cations is still affected by the first-type adhesive tape; a larger area of the active material layer shielded by the first-type adhesive tape results in a smaller speed of absorbing and releasing the metal cations. Therefore, by ensuring that along the length direction of the positive electrode current collector, the width of the third adhesive tape is less than the width of the first adhesive tape and the width of the fourth adhesive tape is less than the width of the first adhesive tape, the areas of the first positive electrode active material layer and the second positive electrode active material layer shielded by the first-type adhesive tape are greater than the areas of the first negative electrode active material layer and the second negative electrode active material layer shielded by the first-type adhesive tape, making the speed at which the first positive electrode active material layer and the second positive electrode active material layer absorb and release metal cations less than the speed at which the first negative electrode active material layer and the second negative electrode active material layer absorb and release metal cations, thereby reducing the probability of metal ion precipitation in the secondary battery.

In some embodiments, the negative electrode plate includes:
a negative electrode current collector;
a first negative electrode active material layer coated on a first surface of the negative electrode current collector, the first negative electrode active material layer is provided with a third groove, and a portion of the negative electrode current collector is exposed from the third groove;
a second negative electrode active material layer coated on a second surface of the negative electrode current collector, the second surface of the negative electrode current collector being opposite to the first surface of the negative electrode current collector; and
a negative electrode tab accommodated in the third groove, the negative electrode tab being connected to the negative electrode current collector; where
the first-type adhesive tape includes a fifth adhesive tape, and the fifth adhesive tape is attached to the first negative electrode active material layer and covers the third groove and the negative electrode tab.

In the above technical solution, the negative electrode tab is accommodated in the third groove, and the negative electrode tab is connected to the negative electrode current collector, so that an external apparatus can be electrically connected to the negative electrode current collector through the negative electrode tab. The fifth adhesive tape is attached to the first negative electrode active material layer and covers the third groove and the negative electrode tab, achieving an insulating effect between the positive electrode plate and the negative electrode plate, and reducing the probability of contact between the negative electrode current collector, the negative electrode tab, and the positive electrode current collector. Additionally, a portion of the first negative electrode active material layer shielded by the fifth adhesive tape can absorb and release metal cations, increasing the discharge capacity of the secondary battery.

In some embodiments, a fourth groove is provided at a position of the second negative electrode active material layer corresponding to the third groove, and a portion of the negative electrode current collector is exposed from the fourth groove; and
the first-type adhesive tape includes a sixth adhesive tape, and the sixth adhesive tape is attached to the second negative electrode active material layer and covers the fourth groove.

In the above technical solution, the sixth adhesive tape is attached to the second negative electrode active material layer and covers the fourth groove, achieving an insulating effect between the positive electrode plate and the negative electrode plate is achieved and reducing the probability of contact between the negative electrode current collector and the positive electrode current collector, thereby improving the reliability of the secondary battery. Additionally, a portion of the second negative electrode active material layer shielded by the sixth adhesive tape can absorb and release metal cations, increasing the discharge capacity of the secondary battery.

In some embodiments, the electrode assembly further includes a second-type adhesive tape, and a substrate of the second-type adhesive tape has no pores. The second-type adhesive tape includes a seventh adhesive tape and an eighth adhesive tape. The seventh adhesive tape is attached to the first positive electrode active material layer, and along the thickness direction of the positive electrode current collector, a projection of the negative electrode tab is located within a projection of the seventh adhesive tape. The eighth adhesive tape is attached to the second positive electrode active material layer, and along the thickness direction of the positive electrode current collector, the projection of the negative electrode tab is located within a projection of the eighth adhesive tape.

In the above technical solution, the seventh adhesive tape and the eighth adhesive tape are provided, the seventh adhesive tape is attached to the first positive electrode active material layer, the projection of the negative electrode tab is located within the projection of the seventh adhesive tape along the thickness direction of the positive electrode current collector, the eighth adhesive tape is attached to the second positive electrode active material layer, and the projection of the negative electrode tab is located within the projection of the eighth adhesive tape along the thickness direction of the positive electrode current collector, achieving an insulating effect between the positive electrode plate and the negative electrode plate. Since the projection of the negative electrode tab is covered by the projections of the seventh adhesive tape and the eighth adhesive tape, the insulating effect of the seventh adhesive tape and the eighth adhesive tape is enhanced, reducing the probability of contact between the negative electrode tab and the positive electrode current collector, thereby improving the reliability of the secondary battery. Since the third groove accommodating the negative electrode tab lacks an active material and cannot receive metal cations, by ensuring that the substrate of the second-type adhesive tape has no pores, a portion of the first positive electrode active material layer shielded by the seventh adhesive tape and a portion of the second positive electrode active material layer shielded by the eighth adhesive tape cannot release metal cations, reducing the probability of metal ion precipitation in the secondary battery.

In some embodiments, the first-type adhesive tape includes a ninth adhesive tape, and the ninth adhesive tape is disposed at a tail end of the positive electrode plate, with a portion attached to the first positive electrode active material layer and another portion attached to the positive electrode current collector.

In the above technical solution, by disposing the ninth adhesive tape at the tail end of the positive electrode plate, with a portion attached to the first positive electrode active material layer and another portion attached to the positive electrode current collector, an insulating effect between the positive electrode plate and the negative electrode plate is achieved, reducing the probability of contact between the positive electrode current collector and the negative electrode plate, thereby improving the reliability of the secondary battery. Additionally, a portion of the first positive electrode active material layer shielded by the ninth adhesive tape can absorb and release metal cations, increasing the discharge capacity of the secondary battery.

In some embodiments, the first-type adhesive tape includes a tenth adhesive tape, and the tenth adhesive tape is disposed at the tail end of the positive electrode plate, with a portion attached to the second positive electrode active material layer and another portion attached to the positive electrode current collector.

In the above technical solution, by disposing the tenth adhesive tape at the tail end of the positive electrode plate, with a portion attached to the second positive electrode active material layer and another portion attached to the positive electrode current collector, an insulating effect between the positive electrode plate and the negative electrode plate is achieved, reducing the probability of contact between the positive electrode current collector and the negative electrode plate, thereby improving the reliability of the secondary battery. Additionally, a portion of the first positive electrode active material layer shielded by the ninth adhesive tape can absorb and release metal cations, increasing the discharge capacity of the secondary battery.

According to a second aspect, this application provides an electric device including the secondary battery as described above, where the secondary battery is configured to provide electrical energy.

### BRIEF DESCRIPTION OF DRAWINGS

To more clearly illustrate the technical solutions of some embodiments of this application, the drawings required for use in some embodiments are briefly introduced below; the drawings described below illustrate only some embodiments of this application and should not be regarded as limiting the scope; and persons of ordinary skill in the art can obtain other related drawings based on these drawings.

FIG. 1 is a schematic cross-sectional structural view of an electrode assembly of a secondary battery according to some embodiments of this application;

FIG. 2 is a schematic partially enlarged structural view of portion A of the electrode assembly in FIG. 1;

FIG. 3 is a schematic cross-sectional view of a partial structure of a secondary battery according to some embodiments of this application; and

FIG. 4 is a schematic cross-sectional structural view of a first-type adhesive tape of a secondary battery according to some embodiments of this application.

Reference signs: 10. electrode assembly; 100. positive electrode plate; 110. positive electrode current collector; 120. first positive electrode active material layer; 121. first groove; 130. second positive electrode active material layer; 131. second groove; 140. positive electrode tab; 200. separator; 300. negative electrode plate; 310. negative electrode current collector; 320. first negative electrode active material layer; 321. third groove; 330. second negative electrode active material layer; 331. fourth groove; 400. first-type adhesive tape; 401. substrate layer; 402. adhesive layer; 410. first adhesive tape; 420. second adhesive tape; 430. third adhesive tape; 440. fourth adhesive tape; 450. fifth adhesive tape; 460. sixth adhesive tape; 470. ninth adhesive tape; 480. tenth adhesive tape; 510. seventh adhesive tape; and 520. eighth adhesive tape.

### DETAILED DESCRIPTION

To make the objectives, technical solutions, and advantages of this application clearer, the technical solutions in some embodiments of this application are described clearly below in conjunction with the drawings in some embodiments of this application; the described embodiments are some embodiments of this application rather than all embodiments; and all other embodiments obtained by persons of ordinary skill in the art based on some embodiments in this application fall within the protection scope of this application.

Unless otherwise defined, all technical and scientific terms used in this application have the same meanings as commonly understood by persons skilled in the technical field of this application; terms used in the specification of this application are for the purpose of describing specific embodiments only and are not intended to limit this application; and the terms “include”, “comprise”, and any variations thereof in the specification, claims, and the above description of drawings of this application are intended to cover non-exclusive inclusion.

The terms “first”, “second”, and the like in the specification, claims, or the above drawings of this application are used to distinguish between different objects and not to describe a specific order or primary-secondary relationship.

Reference to “embodiment” in this application means that a specific feature, structure, or characteristic described in conjunction with the embodiment may be included in at least one embodiment of this application; and the appearance of this phrase in various positions in the specification does not necessarily refer to the same embodiment, nor is it an independent or alternative embodiment mutually exclusive with other embodiments.

In some embodiments of this application, identical reference signs denote identical components, and for brevity, detailed descriptions of identical components are omitted in different embodiments. It should be understood that the dimensions such as thickness, length, and width of various members and the dimensions such as thickness, length, and width of integrated apparatuses shown in the accompanying drawings in some embodiments of this application are for illustrative purposes only and should not constitute any limitation on this application.

With the development of the new energy industry, batteries are gradually advancing toward high discharge capacity. In an electrode assembly of a secondary battery, for installing a tab, a portion of an active material layer needs to be removed from an electrode plate to expose a current collector to form a groove, so as to allow a portion of the current collector of the electrode plate to be exposed from the groove, so that the tab accommodated in the groove can be electrically connected to the current collector. In addition, to reduce the probability of a short circuit between the positive electrode plate and the negative electrode plate, an adhesive tape needs to be provided on the active material layer to cover the tab and the groove. A portion of the active material layer shielded by the adhesive tape cannot absorb and release metal ions, reducing the discharge capacity of the secondary battery.

To increase the discharge capacity of an electrochemical apparatus, this application provides a secondary battery including a housing, an electrolyte, and an electrode assembly. The electrode assembly and the electrolyte are accommodated in the housing. The electrode assembly includes a positive electrode plate, a separator, a negative electrode plate, and a first-type adhesive tape. The separator is disposed between the positive electrode plate and the negative electrode plate. The first-type adhesive tape includes a substrate layer, and a thickness of the substrate layer is H μm and 8≤H≤20. The substrate layer has pores for metal cations to pass through, and a porosity of the substrate layer is φ, satisfying 20%≤φ≤60%. The positive electrode plate includes a positive electrode current collector, a first positive electrode active material layer, a second positive electrode active material layer, and a positive electrode tab. The first positive electrode active material layer is coated on a first surface of the positive electrode current collector. The first positive electrode active material layer is provided with a first groove, and a portion of the positive electrode current collector is exposed from the first groove. The second positive electrode active material layer is coated on a second surface of the positive electrode current collector, the second surface of the positive electrode current collector being opposite to the first surface of the positive electrode current collector. The positive electrode tab is accommodated in the first groove, and the positive electrode tab is electrically connected to the positive electrode current collector. The first-type adhesive tape includes a first adhesive tape, and the first adhesive tape is attached to the first positive electrode active material layer and covers the first groove and the positive electrode tab.

In the secondary battery with this structure, the first-type adhesive tape includes a substrate layer, and the thickness of the substrate layer is H μm and satisfies 8≤H≤20. On one hand, this enables burrs on the positive electrode tab to be less likely to penetrate through the first-type adhesive tape and contact the negative electrode plate. On the other hand, this enables the first-type adhesive tape to have a small size in the thickness direction of the positive electrode current collector, resulting in a small impact on the discharge capacity of the secondary battery. The substrate layer has pores for metal cations to pass through, and the porosity of the substrate layer is φ, satisfying 20%≤φ≤60%. On one hand, this enables metal cations to pass through the first-type adhesive tape, so that the portion of the first positive electrode active material layer covered by the first-type adhesive tape can also absorb and release metal cations, thus increasing an effective area of the first positive electrode active material layer and increasing the discharge capacity of the secondary battery. On the other hand, the probability of deformation of the first-type adhesive tape during the preparation process of the secondary battery can be reduced.

The secondary battery in this embodiment of this application may be a lithium-ion battery, a sodium-ion battery, a magnesium-ion battery, or the like, and this is not limited in this embodiment of this application. The secondary battery may be a cylinder, a flat body, a cuboid, or of other shapes, and this is not limited in this embodiment of this application either.

An embodiment of this application provides an electric device using a secondary battery as a power source, and the electric device includes, but is not limited to, a mobile phone, a tablet, a laptop, an electric toy, an electric tool, an electric bicycle, an electric vehicle, a ship, a spacecraft, and the like.

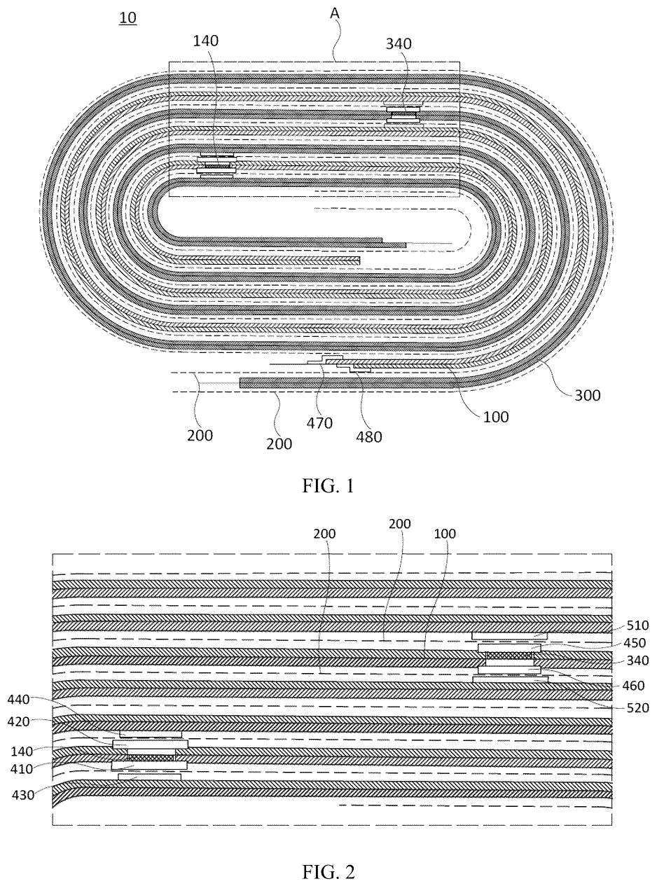

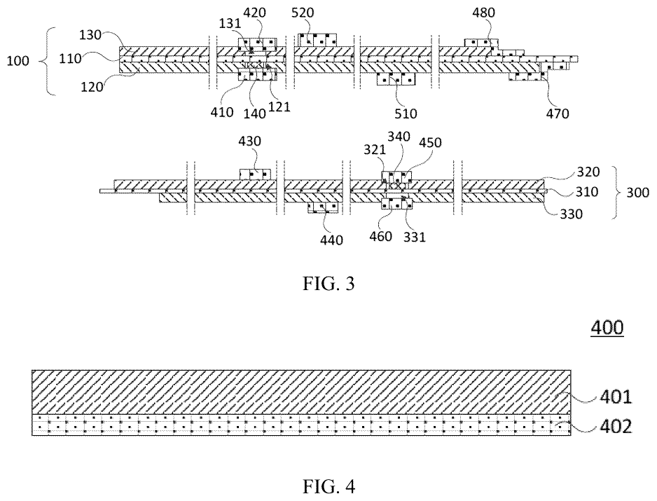

Referring to FIGS. 1 to 3, FIG. 1 is a schematic cross-sectional structural view of an electrode assembly of a secondary battery according to some embodiments of this application; FIG. 2 is a schematic partially enlarged structural view of portion A of the electrode assembly in FIG. 1; and FIG. 3 is a schematic cross-sectional view of a partial structure of a secondary battery according to some embodiments of this application.

This embodiment of this application provides a secondary battery. The secondary battery includes a housing (not shown in the figure), an electrolyte (not shown in the figure), and an electrode assembly 10. The electrode assembly 10 and the electrolyte are accommodated in the housing. The electrode assembly 10 includes a positive electrode plate 100, a separator 200, a negative electrode plate 300, and a first-type adhesive tape 400. The separator 200 is disposed between the positive electrode plate 100 and the negative electrode plate 300.

In some embodiments, the positive electrode plate 100 includes a positive electrode current collector 110, a first positive electrode active material layer 120, a second positive electrode active material layer 130, and a positive electrode tab 140. The first positive electrode active material layer 120 is coated on a first surface of the positive electrode current collector 110. The first positive electrode active material layer 120 is provided with a first groove 121, and a portion of the positive electrode current collector 110 is exposed from the first groove 121. The second positive electrode active material layer 130 is coated on a second surface of the positive electrode current collector 110, the second surface of the positive electrode current collector 110 being opposite to the first surface of the positive electrode current collector 110. The positive electrode tab 140 is accommodated in the first groove 121, and the positive electrode tab 140 is electrically connected to the positive electrode current collector 110.

Taking a lithium-ion battery as an example, the positive electrode current collector 110 may be made of aluminum, and the first positive electrode active material layer 120 and the second positive electrode active material layer 130 may be lithium cobalt oxide, lithium iron phosphate, a ternary material, or lithium manganese oxide. The positive electrode tab 140 and the positive electrode current collector 110 may be made of a same material, facilitating welding of the positive electrode tab 140 to the positive electrode current collector 110.

The separator may be made of polypropylene (PP) or polyethylene (PE). The electrolyte may include an organic solvent, an electrolytic lithium salt, and the like.

In some embodiments, the first-type adhesive tape 400 includes a first adhesive tape 410. The first adhesive tape 410 is attached to the first positive electrode active material layer 120 and covers the first groove 121 and the positive electrode tab 140, achieving an insulating effect between the positive electrode plate 100 and the negative electrode plate 300, thereby reducing the probability of contact between the positive electrode tab 140 and the negative electrode plate 300.

In some embodiments, the first-type adhesive tape 400 includes a substrate layer 401, and a thickness of the substrate layer 401 is H μm and 8≤H≤20. For example, H μm may be 8 μm, 14 μm, 20 μm, or the like.

By ensuring that the thickness H μm of the substrate layer 401 satisfies 8 μm ≤H μm≤20 μm, on one hand, burrs on the positive electrode tab 140 are less likely to penetrate through the first-type adhesive tape 400 and contact the negative electrode plate 300; on the other hand, the first-type adhesive tape 400 can have a small size in the thickness direction of the positive electrode current collector 110, resulting in a small impact on the discharge capacity of the secondary battery.

In some embodiments, the substrate layer 401 has pores for metal cations to pass through, and a porosity of the substrate layer 401 is φ, satisfying 20%≤φ≤60%. For example, φ may be 20%, 40%, 60%, or the like. On one hand, metal cations can pass through the first-type adhesive tape 400, thereby allowing a portion of the first positive electrode active material layer 120 covered by the first-type adhesive tape 400 to also absorb and release metal cations, thus increasing an effective area of the first positive electrode active material layer 120 and increasing the discharge capacity of the secondary battery. On the other hand, the probability of deformation of the first-type adhesive tape 400 during the preparation process of the secondary battery can be reduced.

In some embodiments, the porosity of the substrate layer 401 is φ, satisfying 30%≤φ≤55%. For example, q may be 30%, 37%, 55%, or the like. On one hand, metal cations can more easily pass through the first-type adhesive tape 400, accelerating the speed at which metal cations pass through the first-type adhesive tape 400 and reducing the probability of metal cation precipitation. On the other hand, the probability of deformation of the first-type adhesive tape 400 during the preparation process of the secondary battery can be further reduced.

In some embodiments, the substrate layer 401 is made of at least one of polyethylene, polypropylene, polyethylene terephthalate, polyimide, polyamide, spandex, or aramid, enabling the substrate layer 401 to have pores with a porosity ranging from 20% to 60%.

In some embodiments, the substrate layer 401 may be a nonwoven fabric, a film, or a composite film made of at least one of polyethylene, polypropylene, polyethylene terephthalate, polyimide, polyamide, spandex, or aramid. For example, the substrate layer 401 may be a polypropylene porous film, a polyethylene porous film, a polypropylene nonwoven fabric, a polyethylene nonwoven fabric, a polypropylene-polyethylene-polypropylene porous composite film, or the like.

In some embodiments, the thickness of the substrate layer 401 is H μm, and 8≤H≤16. For example, H μm may be 8 μm, 12 μm, 16 μm, or the like. On one hand, burrs on the positive electrode tab 140 can be further prevented from penetrating through the first-type adhesive tape 400 and contacting the negative electrode plate 300. On the other hand, the first-type adhesive tape 400 can have a small size in the thickness direction of the positive electrode current collector 110, resulting in a small impact on the discharge capacity of the secondary battery.

In some embodiments, the thickness of the substrate layer 401 is H μm, and 10≤H≤16. For example, H μm may be 10 μm, 13 μm, 16 μm, or the like.

In some embodiments, the thickness of the substrate layer 401 is H, and the porosity of the substrate layer 401 is φ, satisfying 14≤H/φ≤67. For example, H/φ may be 14, 40, 67, or the like.

Since the value of H/φ in the substrate layer 401 is positively correlated with the impedance of the substrate layer 401, and the thickness H of the substrate layer 401 and the porosity q of the substrate layer 401 satisfy 14≤H/φ≤67. On one hand, the substrate layer 401 can have a certain impedance, facilitating the preparation of the substrate layer 401. On the other hand, the impedance of the substrate layer 401 can be reduced, thereby reducing the probability of metal ion precipitation in the secondary battery.

Referring to FIG. 4, FIG. 4 is a schematic cross-sectional structural view of a first-type adhesive tape of a secondary battery according to some embodiments of this application.

In some embodiments, the first-type adhesive tape 400 further includes an adhesive layer 402, and the adhesive layer 402 and the substrate layer 401 are stacked.

The first-type adhesive tape 400 is provided with an adhesive layer 402, and the adhesive layer 402 and the substrate layer 401 are stacked, facilitating attachment of the first-type adhesive tape 400, thereby making the position of the first-type adhesive tape 400 more stable after attachment.

In some embodiments, the adhesive layer 402 is made of at least one of polyolefin, polyacrylate, polyacrylic acid, or derivatives thereof, enabling good adhesion of the adhesive layer 402.

Referring to FIGS. 1 to 3, in some embodiments, a second groove 131 is provided at a position of the second positive electrode active material layer 130 corresponding to the first groove 121, and a portion of the positive electrode current collector 110 is exposed from the second groove 131. The first-type adhesive tape 400 further includes a second adhesive tape 420, and the second adhesive tape 420 is attached to the second positive electrode active material layer 130 and covers the second groove 131.

The position of the second positive electrode active material layer 130 corresponding to the first groove 121 being provided with the second groove 131 means that projections of the first groove 121 and the second groove 131 overlap in the thickness direction of the positive electrode current collector 110.

The second adhesive tape 420 is attached to the second positive electrode active material layer 130 and covers the second groove 131, achieving an insulating effect between the positive electrode plate 100 and the negative electrode plate 300, and reducing the probability of contact between the positive electrode current collector 110 and the negative electrode plate 300, thereby improving the reliability of the secondary battery. Additionally, a portion of the second positive electrode active material layer 130 shielded by the second adhesive tape 420 can absorb and release metal cations, increasing the discharge capacity of the secondary battery.

In some embodiments, the negative electrode plate 300 includes a negative electrode current collector 310, a first negative electrode active material layer 320, and a second negative electrode active material layer 330. The first negative electrode active material layer 320 is coated on a first surface of the negative electrode current collector 310. The second negative electrode active material layer 330 is coated on a s second surface of the negative electrode current collector 310, the first surface of the negative electrode current collector 310 being opposite to the second surface of the negative electrode current collector 310.

Taking a lithium-ion battery as an example, the negative electrode current collector 310 may be made of copper, and the first negative electrode active material layer 320 and the second negative electrode active material layer 330 may be made of a carbon material or a silicon material.

In some embodiments, the first-type adhesive tape 400 includes a third adhesive tape 430, the third adhesive tape 430 is attached to the first negative electrode active material layer 320, and along ta thickness direction of the negative electrode current collector 310, a projection of the positive electrode tab 140 is located within a projection of the third adhesive tape 430, achieving an insulating effect between the positive electrode plate 100 and the negative electrode plate 300. Since the projection of the positive electrode tab 140 is covered by the projection of the third adhesive tape 430, the insulating effect of the third adhesive tape 430 is enhanced, reducing the probability of contact between the positive electrode tab 140 and the negative electrode plate 300, thereby improving the reliability of the secondary battery. Additionally, a portion of the first negative electrode active material layer 320 shielded by the third adhesive tape 430 can absorb and release metal cations, increasing the discharge capacity of the secondary battery.

A total thickness of the first adhesive tape 410, the separator 200, and the third adhesive tape 430 is an insulation thickness between the positive electrode tab 140 and the negative electrode current collector 310, meaning that burrs on the positive electrode tab 140 should sequentially penetrate the first adhesive tape 410, the separator 200, and the third adhesive tape 430 to contact the negative electrode current collector 310.

In some embodiments, the first-type adhesive tape 400 further includes a fourth adhesive tape 440, the fourth adhesive tape 440 is attached to the second negative electrode active material layer 330, and along the thickness direction of the negative electrode current collector 310, the projection of the positive electrode tab 140 is located within a projection of the fourth adhesive tape 440.

The fourth adhesive tape 440 is attached to the second negative electrode active material layer 330, and the projection of the positive electrode tab 140 is located within the projection of the fourth adhesive tape 440 along the thickness direction of the negative electrode current collector 310, achieving an insulating effect between the positive electrode plate 100 and the negative electrode plate 300. Since the projection of the positive electrode tab 140 is covered by the projection of the fourth adhesive tape 440, the insulating effect of the fourth adhesive tape 440 is enhanced, reducing the probability of contact between the positive electrode tab 140 and the negative electrode plate 300, thereby improving the reliability of the secondary battery. Additionally, a portion of the second negative electrode active material layer 330 shielded by the fourth adhesive tape 440 can absorb and release metal cations, increasing the discharge capacity of the secondary battery.

A total thickness of the second adhesive tape 420, the separator 200, and the fourth adhesive tape 440 is an insulation thickness between the positive electrode current collector 110 and the negative electrode current collector 310, meaning that burrs on the positive electrode current collector 110 should sequentially penetrate the second adhesive tape 420, the separator 200, and the fourth adhesive tape 440 to contact the negative electrode current collector 310.

In some embodiments, along a length direction of the positive electrode current collector 110, a width of the third adhesive tape 430 is less than a width of the first adhesive tape 410, and a width of the fourth adhesive tape 440 is less than the width of the first adhesive tape 410.

Since metal cations can pass through the first-type adhesive tape 400, the speed at which the portion of the active material layer shielded by the first-type adhesive tape 400 absorbs and releases metal cations is still affected by the first-type adhesive tape 400, and a larger area of the active material layer shielded by the first-type adhesive tape 400 results in a smaller speed of absorbing and releasing the metal cations. Therefore, by ensuring that along the length direction of the positive electrode current collector 110, the width of the third adhesive tape 430 is less than the width of the first adhesive tape 410 and the width of the fourth adhesive tape 440 is less than the width of the first adhesive tape 410, the areas of the first positive electrode active material layer 120 and the second positive electrode active material layer 130 shielded by the first-type adhesive tape 400 are greater than the areas of the first negative electrode active material layer 320 and the second negative electrode active material layer 330 shielded by the first-type adhesive tape 400, making the speed at which the first positive electrode active material layer 120 and the second positive electrode active material layer 130 absorb and release metal cations less than the speed at which the first negative electrode active material layer 320 and the second negative electrode active material layer 330 absorb and release metal cations, thereby reducing the probability of metal ion precipitation in the secondary battery.

In some embodiments, a third groove 321 is provided in the first negative electrode active material layer 320, and a portion of the negative electrode current collector 310 is exposed from the third groove 321. The negative electrode plate 300 further includes a negative electrode tab 340, the negative electrode tab 340 is accommodated in the third groove 321, and the negative electrode tab 340 is connected to the negative electrode current collector 310.

The negative electrode tab 340 electrically connected to the negative electrode current collector 310, so that an external apparatus can be electrically connected to the negative electrode current collector 310 through the negative electrode tab 340.

In some embodiments, the first-type adhesive tape 400 includes a fifth adhesive tape 450, and the fifth adhesive tape 450 is attached to the first negative electrode active material layer 320 and covers the third groove 321 and the negative electrode tab 340.

The negative electrode tab 340 is accommodated in the third groove 321, and the negative electrode tab 340 is connected to the negative electrode current collector 310, an external apparatus can be electrically connected to the negative electrode current collector 310 through the negative electrode tab 340. The fifth adhesive tape 450 is attached to the first negative electrode active material layer 320 and covers the third groove 321 and the negative electrode tab 340, achieving an insulating effect between the positive electrode plate 100 and the negative electrode plate 300, and reducing the probability of contact between the negative electrode current collector 310, the negative electrode tab 340, and the positive electrode current collector 110. Additionally, a portion of the first negative electrode active material layer 320 shielded by the fifth adhesive tape 450 can absorb and release metal cations, increasing the discharge capacity of the secondary battery.

In some embodiments, a fourth groove 331 is provided at a position of the second negative electrode active material layer 330 corresponding to the third groove 321, and a portion of the negative electrode current collector 310 is exposed from the fourth groove 331. The first-type adhesive tape 400 includes a sixth adhesive tape 460, and the sixth adhesive tape 460 is attached to the second negative electrode active material layer 330 and covers the fourth groove 331.

The position of the second negative electrode active material layer 330 corresponding to the third groove 321 being provided with the fourth groove 331 means that projections of the third groove 321 and the fourth groove 331 overlap in the thickness direction of the negative electrode current collector 310.

The sixth adhesive tape 460 is attached to the second negative electrode active material layer 330 and covers the fourth groove 331, achieving an insulating effect between the positive electrode plate 100 and the negative electrode plate 300, reducing the probability of contact between the negative electrode current collector 310 and the positive electrode current collector 110, thereby improving the reliability of the secondary battery. Additionally, a portion of the second negative electrode active material layer 330 shielded by the sixth adhesive tape 460 can absorb and release metal cations, increasing the discharge capacity of the secondary battery.

In some embodiments, the electrode assembly 10 further includes a second-type adhesive tape; a substrate of the second-type adhesive tape has no pores; the second-type adhesive tape includes a seventh adhesive tape 510 and an eighth adhesive tape 520; the seventh adhesive tape 510 is attached to the first positive electrode active material layer 120, and along the thickness direction of the positive electrode current collector 110, a projection of the negative electrode tab 340 is located within a projection of the seventh adhesive tape 510; the eighth adhesive tape 520 is attached to the second positive electrode active material layer 130, and along the thickness direction of the positive electrode current collector 110, the projection of the negative electrode tab 340 is located within a projection of the eighth adhesive tape 520; and the substrate of the second-type adhesive tape having no pores means that the second-type adhesive tape does not allow metal cations to pass through.

This can achieve an insulating effect between the positive electrode plate 100 and the negative electrode plate 300, and since the projection of the negative electrode tab 340 is covered by the projections of the seventh adhesive tape 510 and the eighth adhesive tape 520, the insulating effect of the third adhesive tape 430 is enhanced, reducing the probability of contact between the negative electrode tab 340 and the positive electrode current collector 110, thereby improving the reliability of the secondary battery. Since the third groove 321 accommodating the negative electrode tab 340 lacks an active material and cannot receive metal cations, by ensuring that the substrate of the second-type adhesive tape has no pores, a portion of the first positive electrode active material layer 120 shielded by the seventh adhesive tape 510 and a portion of the second positive electrode active material layer 130 shielded by the eighth adhesive tape 520 cannot release metal cations, reducing the probability of metal ion precipitation in the secondary battery.

An adhesive tape with a porosity of less than 5% is considered as a non-porous adhesive tape.

A total thickness of the fifth adhesive tape 450, the separator 200, and the seventh adhesive tape 510 is an insulation thickness between the negative electrode tab 340 and the positive electrode current collector 110, meaning that burrs on the negative electrode tab 340 should sequentially penetrate the fifth adhesive tape 450, the separator 200, and the seventh adhesive tape 510 to contact the positive electrode current collector 110.

A total thickness of the sixth adhesive tape 460, the separator 200, and the eighth adhesive tape 520 is an insulation thickness between the negative electrode current collector 310 and the positive electrode current collector 110, meaning that burrs on the negative electrode current collector 310 should sequentially penetrate the sixth adhesive tape 460, the separator 200, and the eighth adhesive tape 520 to contact the positive electrode current collector 110.

In some embodiments, the first-type adhesive tape 400 includes a ninth adhesive tape 470, and the ninth adhesive tape 470 is disposed at a tail end of the positive electrode plate 100, with a portion attached to the first positive electrode active material layer 120 and another portion attached to the positive electrode current collector 110. This configuration achieves an insulating effect between the positive electrode plate 100 and the negative electrode plate 300, reducing the probability of contact between the positive electrode current collector 110 and the negative electrode plate 300, thereby improving the reliability of the secondary battery. Additionally, a portion of the first positive electrode active material layer 120 shielded by the ninth adhesive tape 470 can absorb and release metal cations, increasing the discharge capacity of the secondary battery.

In some embodiments, the first-type adhesive tape 400 includes a tenth adhesive tape 480, and the tenth adhesive tape 480 is disposed at the tail end of the positive electrode plate 100, with a portion attached to the second positive electrode active material layer 130 and another portion attached to the positive electrode current collector 110.

This configuration achieves an insulating effect between the positive electrode plate 100 and the negative electrode plate 300, reducing the probability of contact between the positive electrode current collector 110 and the negative electrode plate 300, thereby improving the reliability of the secondary battery. Additionally, a portion of the first positive electrode active material layer 120 shielded by the ninth adhesive tape 470 can absorb and release metal cations, increasing the discharge capacity of the secondary battery.

In some other embodiments, the third adhesive tape 430, the fourth adhesive tape 440, the fifth adhesive tape 450, and the sixth adhesive tape 460 may alternatively be a second-type adhesive tape, with no limitation imposed here.

For example, in some embodiments, the first adhesive tape 410, the second adhesive tape 420, the third adhesive tape 430, the fourth adhesive tape 440, the ninth adhesive tape 470, and the tenth adhesive tape 480 are a first-type adhesive tape, while the seventh adhesive tape 510, the eighth adhesive tape 520, the fifth adhesive tape 450, and the sixth adhesive tape 460 are a second-type adhesive tape.

For another example, in some embodiments, the first adhesive tape 410, the second adhesive tape 420, the ninth adhesive tape 470, and the tenth adhesive tape 480 are a first-type adhesive tape, while the third adhesive tape 430, the fourth adhesive tape 440, the seventh adhesive tape 510, the eighth adhesive tape 520, the fifth adhesive tape 450, and the sixth adhesive tape 460 are a second-type adhesive tape.

For still another example, in some embodiments, the first adhesive tape 410, the second adhesive tape 420, the ninth adhesive tape 470, the tenth adhesive tape 480, the fifth adhesive tape 450, and the sixth adhesive tape 460 are a first-type adhesive tape, while the third adhesive tape 430, the fourth adhesive tape 440, the seventh adhesive tape 510, and the eighth adhesive tape 520 are a second-type adhesive tape.

For yet another example, in some embodiments, the first adhesive tape 410, the second adhesive tape 420, the third adhesive tape 430, the fourth adhesive tape 440, the ninth adhesive tape 470, and the tenth adhesive tape 480 are a first-type adhesive tape, while the fifth adhesive tape 450, the sixth adhesive tape 460, the seventh adhesive tape 510, and the eighth adhesive tape 520 are a second-type adhesive tape.

Referring to Table 1, in Table 1, φ represents the porosity of the substrate layer 401 of the first-type adhesive tape 400; and H represents the thickness of the substrate layer 401 of the first-type adhesive tape 400, measured in μm. Referring to FIGS. 2 and 3, the position on the side of the positive electrode tab 140 away from the positive electrode current collector 110 in FIGS. 2 and 3 is position 1; the first adhesive tape 410 is attached to cover the first groove 121 and the positive electrode tab 140; the position where the second groove 131 is located is position 2; the second adhesive tape 420 is attached to the second positive electrode active material layer 130 and coves the second groove 131; the position on the first positive electrode active material layer 120 in FIG. 2 corresponding to the negative electrode tab 340 along the thickness direction of the positive electrode current collector 110 is position 3; the seventh adhesive tape 510 is attached to the first positive electrode active material layer 120 at a position corresponding to the negative electrode tab 340; the position on the second positive electrode active material layer 130 in FIG. 2 corresponding to the negative electrode tab 340 along the thickness direction of the positive electrode current collector 110 is position 4; the eighth adhesive tape 520 is attached to the second positive electrode active material layer 130 at a position corresponding to the negative electrode tab 340; the tail end of the second positive electrode active material layer 130 is position 5; a portion of the tenth adhesive tape 480 is attached to the tail end of the second positive electrode active material layer 130 and another portion is attached to the positive electrode current collector 110; the tail end of the first positive electrode active material layer 120 is position 6; a portion of the ninth adhesive tape 470 is attached to the tail end of the first positive electrode active material layer 120 and another portion is attached to the positive electrode current collector 110; the position on the first negative electrode active material layer 320 in FIG. 2 corresponding to the positive electrode tab 140 along the thickness direction of the negative electrode current collector 310 is position 7; the third adhesive tape 430 is attached to the first negative electrode active material layer 320 at a position corresponding to the positive electrode tab 140; the position on the second negative electrode active material layer 330 in FIG. 2 corresponding to the positive electrode tab 140 along the thickness direction of the negative electrode current collector 310 is position 8; the fourth adhesive tape 440 is attached to the second negative electrode active material layer 330 at a position corresponding to the positive electrode tab 140; the position on the side of the negative electrode tab 340 away from the negative electrode current collector 310 in FIGS. 2 and 3 is position 9; the fifth adhesive tape 450 is attached to cover the third groove 321 and the negative electrode tab 340; the position where the fourth groove 331 is located is position 10; and the sixth adhesive tape 460 is attached to the second negative electrode active material layer 330 and covers the fourth groove 331. H1 represents the sum of the thicknesses of two layers of the first-type adhesive tape and the thickness of the separator (that is, the insulation thickness between the tab and the current collector or between the positive electrode current collector and the negative electrode current collector), measured in μm. Q represents the discharge capacity of the secondary battery, measured in mAh. The thickness of the separator 200 is 8 μm.

In examples and comparative examples, preparation was performed according to the parameters in Table 1, specifically as follows.

A preparation method of a secondary battery was as follows.

(1) Preparation of first-type adhesive tape: A water-based polyacrylate was used as an adhesive and applied onto one side of a polypropylene substrate layer using a micro-gravure coating method, a release agent was applied onto another side of the substrate layer, and after winding, the substrate layer was slit to prepare a roll of adhesive tape.

(2) Preparation of negative electrode plate: A negative electrode active material graphite, a negative electrode thickener sodium carboxymethyl cellulose, and a negative electrode binder styrene-butadiene rubber were mixed at a mass ratio of 98:1:1, added with deionized water, and stirred uniformly to prepare a negative electrode active material layer slurry; the slurry passed through a 200-mesh sieve to prepare a negative electrode active material layer slurry with a solid content of 40% to 45%; copper foil was used as a negative electrode current collector, and the negative electrode active material layer slurry was applied onto the negative electrode current collector; and after drying at 80° C., cold pressing, and slitting, a negative electrode plate was obtained.

TABLE 1
Preparation parameters and performance test of secondary batteries

| | | | | Position of | | Position of | | |
|---|---|---|---|---|---|---|---|---|
| | | | | first-type | | second-type | Discharge | Presence of |
| | | | | adhesive | | adhesive | capacity | short |
| | φ | H | H/φ | tape | H1 | tape | Q (mAh) | circuit |
| Comparative | 0 | 8 | / | 1, 2, 7, 8, | 24 | 3, 4, 9, | 4000 | No |
| Example 1 | | | | 5, 6 | | 10 | | |
| Comparative | 10% | 8 | 80.0 | 1, 2, 7, 8, | 24 | 3, 4, 9, | 4000 | No |
| Example 2 | | | | 5, 6 | | 10 | | |
| Comparative | 15% | 8 | 53.3 | 1, 2, 7, 8, | 24 | 3, 4, 9, | 4000 | No |
| Example 3 | | | | 5, 6 | | 10 | | |
| Comparative | 20% | 6 | 30.0 | 1, 2, 7, 8, | 20 | 3, 4, 9, | 4028 | Yes |
| Example 4 | | | | 5, 6 | | 10 | | |
| Example 1 | 20% | 8 | 40.0 | 1, 2, 7, 8, | 24 | 3, 4, 9, | 4028 | No |
| | | | | 5, 6 | | 10 | | |
| Example 2 | 30% | 10 | 33.3 | 1, 2, 7, 8, | 28 | 3, 4, 9, | 4028 | No |
| | | | | 5, 6 | | 10 | | |
| Example 3 | 40% | 16 | 40.0 | 1, 2, 7, 8, | 40 | 3, 4, 9, | 4028 | No |
| | | | | 5, 6 | | 10 | | |
| Example 4 | 50% | 10 | 20.0 | 1, 2, 7, 8, | 28 | 3, 4, 9, | 4028 | No |
| | | | | 5, 6 | | 10 | | |
| Example 5 | 50% | 12 | 24.0 | 1, 2, 7, 8, | 32 | 3, 4, 9, | 4028 | No |
| | | | | 5, 6 | | 10 | | |
| Example 6 | 50% | 18 | 36.0 | 1, 2, 7, 8, | 44 | 3, 4, 9, | 4028 | No |
| | | | | 5, 6 | | 10 | | |
| Example 7 | 55% | 20 | 36.4 | 1, 2, 7, 8, | 48 | 3, 4, 9, | 4028 | No |
| | | | | 5, 6 | | 10 | | |
| Example 8 | 60% | 10 | 16.7 | 1, 2, 7, 8, | 28 | 3, 4, 9, | 4028 | No |
| | | | | 5, 6 | | 10 | | |
| Comparative | 65% | 10 | 15.4 | 1, 2, 7, 8, | 28 | 3, 4, 9, | 4028 | No |
| Example 5 | | | | 5, 6 | | 10 | | |
| Comparative | 55% | 25 | 45.5 | 1, 2, 7, 8, | 58 | 3, 4, 9, | 4000 | No |
| Example 6 | | | | 5, 6 | | 10 | | |
| Example 9 | 30% | 8 | 26.7 | 1, 2, 7, 8, | 24 | 3, 4, 9, | 4028 | No |
| | | | | 5, 6 | | 10 | | |
| Example 10 | 35% | 8 | 22.9 | 1, 2, 7, 8, | 24 | 3, 4, 9, | 4028 | No |
| | | | | 5, 6 | | 10 | | |
| Example 11 | 40% | 8 | 20.0 | 1, 2, 7, 8, | 24 | 3, 4, 9, | 4028 | No |
| | | | | 5, 6 | | 10 | | |
| Example 12 | 45% | 8 | 17.8 | 1, 2, 7, 8, | 24 | 3, 4, 9, | 4028 | No |
| | | | | 5, 6 | | 10 | | |
| Example 13 | 50% | 8 | 16.0 | 1, 2, 7, 8, | 24 | 3, 4, 9, | 4028 | No |
| | | | | 5, 6 | | 10 | | |
| Example 14 | 55% | 8 | 14.5 | 1, 2, 7, 8, | 24 | 3, 4, 9, | 4028 | No |
| | | | | 5, 6 | | 10 | | |
| Comparative | 50% | 8 | 16.0 | 1, 2, 5, 6, | 26 | 7, 8 | 4008 | / |
| Example 7 | | | | 9, 10 | | | | |
| Comparative | 50% | 8 | 16.0 | 1, 2, 7, 8, | 26 | 5, 6 | 4020 | / |
| Example 8 | | | | 9, 10 | | | | |
| Comparative | 50% | 8 | 16.0 | 1, 2, 5, 6, | 26 | 9, 10 | / | / |
| Example 9 | | | | 7, 8, 3, 4 | | | | |
| Example 15 | 50% | 16 | 32.0 | 1, 2, 5, 6 | 24 | 3, 4, 9, | 4028 | No |
| | | | | | | 10 | | |
| Example 16 | 50% | 16 | 32.0 | 1, 2, 5, 6, | 24 | 3, 4 | 4028 | No |
| | | | | 9, 10 | | | | |
| Example 17 | 50% | 8 | 16.0 | 1, 2, 7, 8, | 24 | 3, 4, 9, | 4028 | No |
| | | | | 5, 6 | | 10 | | |
| Example 18 | 50% | 8 | 16.0 | 1, 2, 7, 8, | 26 | 3, 4 | 4028 | No |
| | | | | 5, 6, 9, | | | | |
| | | | | 10 | | | | |

(3) Preparation of separator: A substrate of the separator was polyethylene (PE) with a thickness of 8 μm, a 2 μm aluminum oxide ceramic layer was applied onto each of the two opposites to surfaces of the substrate, and finally, a binder polyvinylidene fluoride (PVDF) was applied onto both sides with the ceramic layers at 2.5 mg/cm², followed by drying.

(4) Preparation of electrolyte: In an environment with a moisture of less than 10 ppm, lithium hexafluorophosphate was mixed with a non-aqueous organic solvent (propylene carbonate (PC):ethylene carbonate (EC):dimethyl carbonate (DMC):ethyl methyl carbonate (EMC)=1:1:0.5:1, weight ratio) to prepare a base electrolyte, LiPF₆ was added, and the mixture was mixed uniformly to obtain an electrolyte, with the concentration of LiPF₆ being 1 mol/L.

(5) Preparation of positive electrode plate: Lithium cobalt oxide, a conductive agent, and a binder polyvinylidene fluoride (PVDF) were dissolved in an N-methylpyrrolidone (NMP) solution at a mass ratio of 97.2:1.5:1.3 to prepare a positive electrode active material layer slurry; the slurry passed through a 200-mesh sieve to prepare a positive electrode active material layer slurry with a solid content of 70% to 75%; a coating machine was used to coat the positive electrode active material layer slurry on a surface of a base-coated positive electrode plate, with a coating thickness of 90 μm, a width of the positive electrode plate being 70 mm, and a length of the positive electrode plate being 1400 mm; and after cold pressing and slitting, a positive electrode plate was obtained.

(6) Preparation of electrochemical apparatus: The positive electrode plate, the separator, and the negative electrode plate were stacked in sequence, with the separator located between the positive electrode plate and the negative electrode plate for isolation, and wound to obtain an electrode assembly; the electrode assembly was placed in an aluminum-plastic film outer package, moisture was removed at 80° C., the above electrolyte was injected, and sealing was performed, followed by processes such as formation, degassing, and edge trimming to obtain a secondary battery.

A method for testing the porosity of the first-type adhesive tape was as follows.

(1) The first-type adhesive tape was removed from the electrode plate, and soaked in a toluene solvent at 45° C. for 10 hours, and this step was repeated twice to obtain a substrate layer sample of the first-type adhesive tape.

(2) The porosity q of the substrate layer was calculated as φ=[1−m/(s*h*ρ)]*100%, where m is the mass of the substrate layer sample, s is the area of the substrate layer sample, h is the thickness of the substrate layer sample, and ρ is the true density of the substrate layer material.

A method for testing the true density of the substrate layer material was as follows.

(1) An area greater than 0.35 cm² was removed from the substrate layer sample, and a true density tester (AccuPyc II 1340) was used to measure the true volume V of the substrate layer sample in a helium environment, and the true volume V was the volume of the substrate layer sample excluding pores.

(2) An electronic balance was used to measure the weight M of the substrate layer sample, and the true density ρ=M/V.

A method for testing the thickness of the first-type adhesive tape was as follows.

(1) The first-type adhesive tape was removed from the electrode plate, and soaked in a toluene solvent at 45° C. for 10 hours, and this step was repeated twice to obtain a substrate layer sample of the first-type adhesive tape.

(2) The thicknesses of six random positions of the substrate layer sample were measured, and an average value was calculated to obtain the thickness of the first-type adhesive tape.

A method for testing the discharge capacity of the secondary battery was as follows.

(1) The secondary battery was placed in an environment at 25° C.

(2) The secondary battery was charged at a constant current of 0.2 C to the charge cutoff voltage of the battery (for example, 4.5 V), and then charged at a constant voltage to 0.02 C.

(3) The secondary battery was left standing for 10 minutes.

(4) The secondary battery was discharged at a constant current of 0.1 C to the discharge cutoff voltage of the battery (for example, 3.0 V), and the discharge capacity of the secondary battery was extracted.

A method for testing short circuits in the secondary battery was as follows.

A Hi-pot test (Hi-pot test) was used to measure the resistance between the positive electrode tab 140 and the negative electrode tab 340 of the electrode assembly 10; if the resistance between the positive electrode tab 140 and the negative electrode tab 340 was less than 20 MΩ, it was determined that the electrode assembly 10 was short-circuited; otherwise, it was determined that the electrode assembly 10 was not short-circuited.

Based on Table 1, the following conclusions can be obtained.

(1) Referring to Comparative Examples 1 to 3 and Examples 1 and 9 to 14, when the first-type adhesive tape was disposed at positions 1, 2, 7, 8, 5, and 6, and the second-type adhesive tape was disposed at positions 3, 4, 9, and 10, with the thickness of the first-type adhesive tape being 8 μm, making the porosity of the first-type adhesive tape be ranged from 20% to 60% could increase the capacity of the secondary battery, and increase the discharge capacity of the secondary battery.

(2) Referring to Examples 1 to 14, when the first-type adhesive tape was disposed at positions 1, 2, 7, 8, 5, and 6, and the second-type adhesive tape was disposed at positions 3, 4, 9, and 10, with the porosity of the first-type adhesive tape ranging from 20% to 60%, the thickness of the first-type adhesive tape ranging from 8 μm to 20 μm, and H/o ranging from 14 to 67, the capacities of the secondary battery was relatively high, resulting in a higher discharge capacity of the secondary battery.

(3) Referring to Comparative Examples 1 to 4, when the first-type adhesive tape was disposed at positions 1, 2, 7, 8, 5, and 6, and the second-type adhesive tape was disposed at positions 3, 4, 9, and 10, with the porosity of the first-type adhesive tape being 20%, if the thickness of the first-type adhesive tape was too small, for example, was 6 μm in Comparative Example 4 (less than 8 μm), although the capacity of the secondary battery was relatively high, the first-type adhesive tape failed to provide a good insulating effect, resulting in a short circuit issue.

(4) Referring to Comparative Example 5 and Examples 2, 4, and 8, when the first-type adhesive tape was disposed at positions 1, 2, 7, 8, 5, and 6, and the second-type adhesive tape was disposed at positions 3, 4, 9, and 10, with the thickness of the first-type adhesive tape being 10 μm, if the porosity of the first-type adhesive tape was too high, for example, was 65% in Comparative Example 5 (greater than 60%), although the capacity of the secondary battery was relatively high, deformation occurred in the first-type adhesive tape during stretching and cutting, leading to changes in the actual thickness of the first-type adhesive tape.

(5) Referring to Comparative Example 6 and Examples 7 and 14, when the first-type adhesive tape was disposed at positions 1, 2, 7, 8, 5, and 6, and the second-type adhesive tape was disposed at positions 3, 4, 9, and 10, with the porosity of the first-type adhesive tape being 55%, if the thickness of the first-type adhesive tape was too large, for example, was 25 μm in Comparative Example 6 (greater than 20 μm), the impedance of the first-type adhesive tape was too high, resulting in a smaller discharge capacity of the secondary battery, affecting the energy density of the secondary battery, and posing a risk of metal ion precipitation in the secondary battery.

(6) Referring to Examples 15 to 18, when the first-type adhesive tape was disposed at positions 1, 2, 5, and 6, or at positions 1, 2, 5, 6, 9, and 10, or at positions 1, 2, 7, 8, 5, and 6, or at positions 1, 2, 7, 8, 5, 6, 9, and 10, with the porosity of the first-type adhesive tape ranging from 20% to 60% and the thickness of the first-type adhesive tape ranging from 8 μm to 20 μm, the discharge capacity of the secondary battery was relatively high, resulting in a higher energy density of the secondary battery.

(7) Referring to Comparative Example 7 and Example 16, when the first-type adhesive tape was disposed at positions 1, 2, 5, 6, 9, and 10, and in Comparative Example 7, the second-type adhesive tape was disposed at positions 7 and 8, although the capacity of the secondary battery increased, the CB value (CellBalance, a ratio of a capacity per unit area of the negative electrode to a capacity per unit area of the positive electrode) at positions 7 and 8 was insufficient, leading to a metal ion precipitation issue.

(8) Referring to Comparative Example 8 and Example 18, when the first-type adhesive tape was disposed at positions 1, 2, 7, 8, 9, and 10, while in Comparative Example 8, positions 5 and 6 were provided with the second-type adhesive tape, and in Example 18, positions 5 and 6 were provided with the first-type adhesive tape, the discharge capacity of the secondary battery was significantly higher, resulting in a higher energy density of the secondary battery.

(9) Referring to Comparative Example 9 and Example 17, when the first-type adhesive tape was disposed at positions 1, 2, 7, 8, 5, and 6, and the second-type adhesive tape was disposed at positions 9 and 10, while in Example 17, positions 3 and 4 were provided with the second-type adhesive tape, and in Comparative Example 9, positions 3 and 4 were provided with the first-type adhesive tape, the CB value at positions 3 and 4 was insufficient, leading to a metal ion precipitation issue.

An embodiment of this application provides an electric device including the secondary battery of any of the above solutions, where the secondary battery is configured to provide electrical energy to the electric device.

The electric device may be any of the aforementioned devices or systems employing a secondary battery.

Without conflict, some embodiments and the features in these embodiments of this application may be combined with each other.

The foregoing descriptions are merely preferred embodiments of this application and are not intended to limit this application; persons skilled in the art understand that this application may have various modifications and variations; and any modifications, equivalent replacements, and improvements made without departing from the spirit and principle of this application shall fall within the protection scope of this application.

What is claimed is:

1. A secondary battery, comprising:
a housing, an electrolyte, and an electrode assembly wherein the electrode assembly and the electrolyte are accommodated in the housing; the electrode assembly further comprises a positive electrode plate, a separator, a negative electrode plate, and a first-type adhesive tape; and the separator is disposed between the positive electrode plate and the negative electrode plate;
the first-type adhesive tape comprises a substrate layer, a thickness of the substrate layer is H μm and 8≤H≤20, the substrate layer has pores for metal cations to pass through, a porosity of the substrate layer is q and 20%≤≤60%;
the positive electrode plate comprises:
a positive electrode current collector;
a first positive electrode active material layer coated on a first surface of the positive electrode current collector, the first positive electrode active material layer is provided with a first groove, and a portion of the positive electrode current collector is exposed from the first groove;
a second positive electrode active material layer coated on a second surface of the positive electrode current collector, the second surface of the positive electrode current collector being opposite to the first surface of the positive electrode current collector; and
a positive electrode tab accommodated in the first groove, the positive electrode tab being electrically connected to the positive electrode current collector;
wherein the first-type adhesive tape comprises a first adhesive tape, and the first adhesive tape is attached to the first positive electrode active material layer and covers the first groove and the positive electrode tab.

2. The secondary battery according to claim 1, wherein 30%≤φ≤55%.

3. The secondary battery according to claim 1, wherein the substrate layer is made of at least one of polyethylene, polypropylene, polyethylene terephthalate, polyimide, polyamide, spandex, or aramid.

4. The secondary battery according to claim 1, wherein 8≤H≤16.

5. The secondary battery according to claim 1, wherein 10≤H≤16.

6. The secondary battery according to claim 1, wherein 14≤H/φ≤67.

7. The secondary battery according to claim 1, wherein the first-type adhesive tape comprises an adhesive layer; the adhesive layer is made of at least one of polyolefin, polyacrylate, polyacrylic acid, or derivatives thereof; and the adhesive layer and the substrate layer are stacked.

8. The secondary battery according to claim 1, wherein a second groove is provided on the second positive electrode active material layer at a position corresponding to the first groove, and a portion of the positive electrode current collector is exposed from the second groove; and
the first-type adhesive tape comprises a second adhesive tape, and the second adhesive tape is attached to the second positive electrode active material layer and covers the second groove.

9. The secondary battery according to claim 1, wherein the negative electrode plate comprises:
a negative electrode current collector;
a first negative electrode active material layer coated on a first surface of the negative electrode current collector; and
a second negative electrode active material layer coated on a second surface of the negative electrode current collector, the first surface of the negative electrode current collector being opposite to the second surface of the negative electrode current collector;
wherein the first-type adhesive tape comprises a third adhesive tape; the third adhesive tape is attached to the first negative electrode active material layer; and along a thickness direction of the negative electrode current collector, a projection of the positive electrode tab is located within a projection of the third adhesive tape.

10. The secondary battery according to claim 9, wherein the first-type adhesive tape comprises a fourth adhesive tape; the fourth adhesive tape is attached to the second negative electrode active material layer; and along the thickness direction of the negative electrode current collector, the projection of the positive electrode tab is located within a projection of the fourth adhesive tape.

11. The secondary battery according to claim 10, wherein along a length direction of the positive electrode current collector, a width of the third adhesive tape is less than a width of the first adhesive tape, and a width of the fourth adhesive tape is less than the width of the first adhesive tape.

12. The secondary battery according to claim 1, wherein the negative electrode plate comprises:
a negative electrode current collector;
a first negative electrode active material layer coated on a first surface of the negative electrode current collector, the first negative electrode active material layer is provided with a third groove, and a portion of the negative electrode current collector is exposed from the third groove;
a second negative electrode active material layer coated on a second surface of the negative electrode current collector, the second surface of the negative electrode current collector being opposites to the first surface of the negative electrode current collector; and
a negative electrode tab accommodated in the third groove, the negative electrode tab being connected to the negative electrode current collector,
wherein the first-type adhesive tape comprises a fifth adhesive tape, and the fifth adhesive tape is attached to the first negative electrode active material layer and covers the third groove and the negative electrode tab.

13. The secondary battery according to claim 12, wherein a fourth groove is provided on the second negative electrode active material layer at a position corresponding to the third groove and a portion of the negative electrode current collector is exposed from the fourth groove; and
the first-type adhesive tape comprises a sixth adhesive tape, and the sixth adhesive tape is attached to the second negative electrode active material layer and covers the fourth groove.

14. The secondary battery according to claim 1, wherein the electrode assembly comprises a second-type adhesive tape; a substrate of the second-type adhesive tape has no pores; the second-type adhesive tape comprises a seventh adhesive tape and an eighth adhesive tape; the seventh adhesive tape is attached to the first positive electrode active material layer; along a thickness direction of the positive electrode current collector, a projection of the negative electrode tab is located within a projection of the seventh adhesive tape; the eighth adhesive tape is attached to the second positive electrode active material layer; and along the thickness direction of the positive electrode current collector, the projection of the negative electrode tab is located within a projection of the eighth adhesive tape.

15. The secondary battery according to claim 1, wherein the first-type adhesive tape comprises a ninth adhesive tape, and the ninth adhesive tape is disposed at a tail end of the positive electrode plate, with a portion attached to the first positive electrode active material layer and another portion attached to the positive electrode current collector.

16. The secondary battery according to claim 15, wherein the first-type adhesive tape comprises a tenth adhesive tape, and the tenth adhesive tape is disposed at the tail end of the positive electrode plate, with a portion attached to the second positive electrode active material layer and another portion attached to the positive electrode current collector.

17. The secondary battery according to claim 12, wherein the electrode assembly comprises a second-type adhesive tape; a substrate of the second-type adhesive tape has no pores; the second-type adhesive tape comprises a seventh adhesive tape and an eighth adhesive tape; the seventh adhesive tape is attached to the first positive electrode active material layer; along a thickness direction of the positive electrode current collector, a projection of the negative electrode tab is located within a projection of the seventh adhesive tape; the eighth adhesive tape is attached to the second positive electrode active material layer; and along the thickness direction of the positive electrode current collector, the projection of the negative electrode tab is located within a projection of the eighth adhesive tape.

18. An electric device, comprising the secondary battery according claim 1, wherein the secondary battery is configured to provide electrical energy.

19. The electric device according to claim 18, wherein 30%≤φ≤55%.

20. The electric device according to claim 18, wherein 14≤H/φ≤67.
